(19) United States
(12) Patent Application Publication
(10) Pub. No.: US 2021/0033246 A1
(43) Pub. Date: Feb. 4, 2021

(54) POLYMORPHOUS RESERVOIR

(71) Applicant: MAHYTEC, Dole (FR)

(72) Inventors: Pascal ROBINET, Besançon (FR); Dominique PERREUX, Pirey (FR); Frédéric THIEBAUD, Fontain (FR)

(73) Assignee: MAHYTEC, Dole (FR)

(21) Appl. No.: 16/969,024

(22) PCT Filed: Feb. 6, 2019
(86) PCT No.: PCT/FR2019/000017

§ 371 Date: Aug. 11, 2020

(30) Foreign Application Priority Data
Feb. 19, 2018 (FR) 1870174

(51) Int. Cl. F17C 11/00; C01B 3/00

(52) U.S. Cl. CPC F17C 11/005; C01B 3/0026; F17C 2203/0648; F17C 2203/0604; F17C 2203/0646; F17C 2203/011; F17C 2221/012; F17C 2260/011; F17C 2205/013; F17C 2203/0658

(57) ABSTRACT

A deformable reservoir for storing solid hydrogen, containing at least one compound that can absorb or release hydrogen, and wherein it includes at least two rigid bars each including a polymer liner defining at least one compartment for storing the compound and accommodated inside a reinforcing structure having globally the shape of a hollow cylinder closed at each of its longitudinal ends by a closing flange, a connection attached to the reinforcing structure of at least one of the bars so as to be sealed to the liner, a flexible union member joining two adjacent bars so as to allow the totality of the storage reservoir to be deformable in spite of the rigidity of each bar.

### TECHNICAL FIELD

The present invention relates to the field of hydride hydrogen reservoirs for storing hydrogen and more specifically reservoirs for a polymer liner reinforced with one or more materials suitable for resisting pressure forces.

### PRIOR ART

Within the scope of the search for alternative energy sources to fossil energies, some gases and in particular hydrogen, non-polluting and wherein the calorific value is high, are looking to be a particularly promising energy carrier.

Conventionally, with a view to subsequent supply thereof as an energy carrier, hydrogen is either stored compressed in a most frequently cylindrical reservoir, or stored in solid form or indeed in liquid form.

The present invention relates to the second mode of storing hydrogen wherein hydrogen is stored by absorption, at a given temperature and pressure, in solid compounds such as metal hydride in powder form. The hydrogen is then rendered, for example, by modifying the temperature and/or pressure conditions.

Said metal hydride powder is conventionally stored in reservoirs generally including a rigid metal shell. The reservoirs of this type are advantageous as they are sufficiently resistant to guarantee a storage of the metal hydride powder in complete safety.

Such reservoirs are already described in international patent application WO 2013/087565 and in European patent application EP 0 188 996. The latter disclose respectively a metal reservoir for storing metal hydride consisting of two parts connected at the level of an assembly zone and each containing a liner, areas for storing hydrogen, heat exchangers, and a pressurised metal reservoir consisting of several liners with removable walls, a filtering tube at the centre and suitable for storing metal hydride.

However, the reservoirs of this type are too rigid to be able to adapt readily to the complex shapes of the supporting members receiving same as well as any movements thereof, in order to promote heat exchanges without impeding said movements.

### DESCRIPTION OF THE INVENTION

The aim of the present invention is therefore that of remedying the drawbacks previously cited by providing a reservoir for storing metal hydride in powder form having a design combining a moderate weight for substantial and long-lasting performances in respect of mechanical strength and flexibility, said reservoir being particularly suitable for mobile use.

In this regard, the present invention relates to a deformable reservoir for storing solid hydrogen, containing at least one compound than can absorb or release hydrogen, the reservoir being remarkable in that it includes at least:
two rigid bars each including a polymer liner including at least a first orifice and defining at least one compartment for storing said compound and a reinforcing structure inside which said liner is accommodated, said reinforcing structure having globally the shape of a hollow cylinder closed at each of the longitudinal ends thereof respectively by a closing flange, and including at least one orifice,
a connection attached to the reinforcing structure of at least one of the bars by being inserted simultaneously into the first orifice of the liner and the orifice of the reinforcing structure, so as to be sealed to the liner and to connect the inside of the storage compartment with the outside of said storage reservoir,
a flexible union member joining two adjacent bars so to render the entire storage reservoir deformable in spite of the rigidity of each bar.

Advantageously, the liner includes at least one internal partition so as to define at least two storage compartments of said compound, each internal partition including an orifice traversing same from end to end and suitable for connecting two adjacent storage compartments.

Preferably, the liner includes a second orifice provided on one of the faces thereof facing one of the flanges and plumb with each internal partition so as to lead into the two storage compartments located on either side of said internal partition and the reservoir includes a filtration clip that can be positioned, via said second orifice, on the internal partition of the liner.

According to a preferred embodiment, said filtration clip has a general U shape and includes two mutually parallel wings and a core connecting the two wings, each of the two wings being equipped with a through orifice disposed so as to be facing the orifice of the internal partition when the clip is positioned thereon, and the clip is equipped with a filter attached to one of the wings thereof plumb with the orifice thereof to prevent any passage of the compound.

Each second orifice of the liner is advantageously associated with a countersink provided on said liner on the opposite side to the associated internal partition and the reservoir includes a sealing member disposed in said countersink and compressed between the associated flange and the clip-liner assembly.

The closing flanges are preferably plates each equipped with a groove that can receive the longitudinal ends of the reinforcing structure.

The liner is advantageously made of reinforced polymer material by three-dimensional printing.

Similarly, each union member is made of reinforced polymer or composite material or metal or indeed light metal alloy, the reinforced polymer union member being preferably made at the same time as the liners by three-dimensional printing.

Advantageously, the closing flanges are metallic, preferably made of aluminium alloy and the reinforcing structure is made of composite material.

### BRIEF DESCRIPTION OF THE FIGURES

Further advantages and features will emerge more clearly from the following description, of a specific embodiment example, given by way of non-restrictive illustration, of a reservoir for storing metal hydride in powder form according to the invention, with reference to the appended figures wherein:

FIG. 1 is a perspective view of a reservoir for storing hydrogen in solid form according to the invention;

FIG. 2 is a side view of one of the bars of the reservoir in FIG. 1;

FIG. 3 is a longitudinal sectional view of the bar in FIG. 2;

FIG. 4 is an enlarged detailed view of the end of the bar in FIG. 2;

FIG. 5 is an enlarged detailed view of the bar in FIG. 2;

FIG. 6 is a longitudinal sectional view of the liner of the bar in FIG. 2;

FIG. 7 is an enlarged detailed view of a clip of the bar in FIG. 2.

### BEST EMBODIMENT OF THE TECHNICAL INVENTION

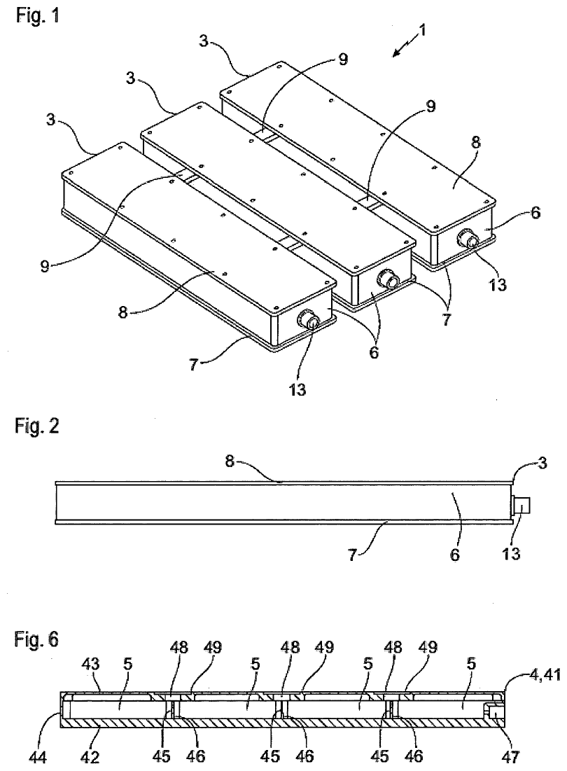

With reference to FIGS. 1 to 7 and in accordance with the invention, a deformable reservoir 1 for storing hydrogen in solid form containing at least one compound 2 that can absorb or release hydrogen, such as for example metal hydride in powder form, has been represented, said reservoir 1 including at least two rigid elements 3 having globally a flattened parallelepipedal shape, hereinafter referred to as bar, and each including a liner 4 defining at least one storage compartment 5 of said compound 2 and accommodated inside a reinforcing structure 6 having globally the shape of a hollow cylinder, and a closing flange 7, 8 attached, substantially tightly, to each of the longitudinal ends of said reinforcing structure 6.

Each bar 3 is rigidly connected to the adjacent bar 3 by at least one flexible union member 9 so as to render the storage reservoir 1 deformable in spite of the rigidity of each bar 3.

“Cylinder” denotes herein a surface defined by a line of constant direction moving along a closed curve of any shape and not merely circular.

In the embodiment example represented in FIGS. 1, 3 and 6, the storage reservoir 1 comprises three bars 3 disposed in succession and each comprising a liner 4 defining four storage compartments 5 also disposed in succession.

However, it is obvious that the number and the arrangement of the bars 3 and/or the storage compartments 5 may vary, without leaving the scope of the present invention.

With reference to FIG. 6, the liner 4 comprises a globally parallelepipedal hollow body 41 including a bottom face 42, a top face 43 and a peripheral face 44 joining said bottom and top faces 42, 43 four storage compartments 5 disposed in succession and separated by an internal partition 45.

The body 41 of the liner 4 includes three internal partitions 45 extending inside said body 41 perpendicularly to the bottom 42, top 43 and peripheral 44 faces, said internal partitions 45 defining inside said body 41 the four storage compartments 5 and each comprising an orifice 46 traversing same from end to end and suitable for connecting two adjacent storage compartments 5.

Furthermore, the body 41 of the liner 4 comprises at least a first orifice 47 provided on the peripheral face 44 thereof and connecting the inside of said body 41 and the outside thereof.

Moreover, the top face 43 of the body 41 of the liner 4 includes a second orifice 48 provided plumb with each internal partition 45 and leading into the two storage compartments 5 located on either side of said internal partition 45. Each second orifice 48 is associated with a countersink 49 provided on said top face 43 of the liner 4 on the opposite side to the associated internal partition 45.

For obvious tightness reasons, the liner 4 is advantageously made of reinforced polymer material by three-dimensional printing.

Moreover, a polymer liner 4 will be more readily deformable and will adapt more readily to the rigid structure of each bar 3 of the storage reservoir 1 according to the invention.

This configuration of a storage reservoir 1 with at least one bar 3 defining several storage compartments 5 is advantageous as it makes it possible to ensure maximum heat exchange with the compound 2 while preventing all of said compound 2 from accumulating at one of the ends of the bar 3 during a movement of the storage reservoir 1 according to the invention.

On the other hand, it is clearly understood that the presence of several storage compartments 5 in each liner 4 is not an essential condition for the deformability of the storage reservoir 1 according to the invention since each bar 3 is rigid due to the reinforcing structure 6 thereof and the closing flanges 7,8 thereof.

With reference to FIGS. 1, 3 and 4, the reinforcing structure 6 having globally the shape of a hollow cylinder includes an orifice 61 provided plumb with the first orifice 47 of the liner 4 when it is positioned in the reinforcing structure 6 and connecting the inside of said reinforcing structure 6 and the outside thereof.

For reasons of mechanical strength and light weight, the reinforcing structure 6 is preferably made of composite material.

With reference to FIGS. 1, 3 and 4, the closing flanges 7, 8 are plates each equipped with a groove 71, 81 that can receive the longitudinal ends 62, 63 of the reinforcing structure 6 in order to enable the assembly thereof with the closing flanges 7, 8. This assembly is held in position using any suitable means such as, for example, bolts exerting a clamping force tending to clamp the closing flanges 7, 8 against the reinforcing structure 6.

For obvious reasons of mechanical strength and light weight, the closing flanges 7, 8 are advantageously metallic and preferably made of aluminium alloy.

With reference to FIG. 1, the storage reservoir 1 comprises two flexible union members 9 connecting two adjacent bars 3. Each union member 9 is preferably of a general strip shape and is attached by each of the ends thereof to the two adjacent bars 3. Each union member is flexible to enable the storage reservoir 1 to deform to adapt to the supporting member received thereby, by allowing a relative movement of the bars 3 in relation to one another. For this, each union member 9 is made of reinforced polymer, composite material or indeed metal or light metal alloy. In the hypothesis where the union members 9 are made of reinforced polymer, the latter may be produced at the same time as the liners 4 preferably by three-dimensional printing.

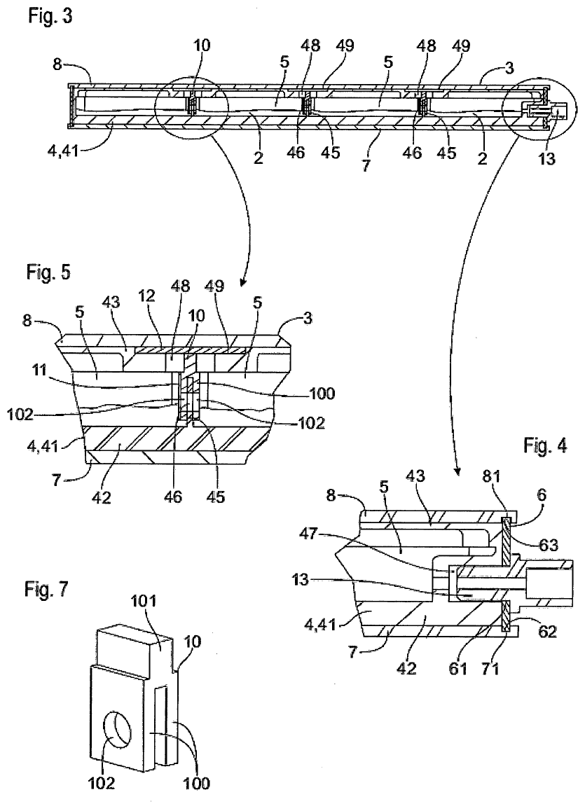

With reference to FIGS. 3, 5 and 7, when the liner 4 defines several storage compartments 5 and includes at least one internal partition 45, the storage reservoir 1 includes at least one filtration clip 10 of a general U shape and includes two mutually parallel wings 100 and a core 101 connecting the two wings 100. Said clip 10 can be positioned on the top part of the internal partition 45 by means of the second associated orifice 48, said top part of the internal partition 45 then being inserted between the two wings 100 of said clip 10 and pressing against the wings 101 of the clip 10.

According to a further embodiment, the clip 10 will be positioned on the bottom part of the internal partition 45, the second orifice 48 should then be provided on the bottom face 42 of the liner 4.

Each of the two wings 100 is furthermore equipped with a through orifice 102 disposed so as to be facing the orifice 46 of the internal partition 45 when the clip 10 is positioned on the top part thereof, in order to allow the passage of hydrogen from one storage compartment 5 to the other.

However, to ensure that only hydrogen passes from one storage compartment 5 to the other, each filtration clip 10 is equipped with a filter 11 attached to one of the wings 100 thereof plumb with the orifice 102 to prevent any passage of the compound 2.

In the same hypothesis, to ensure tightness plumb with the clip of the second orifice 48 of the liner 4, the storage reservoir 1 according to the invention further comprises a sealing member 12 disposed in the associated countersink 49 of the liner 4 and compressed between the flange 8 and the clip 10-liner 4 assembly.

Finally, with reference to FIGS. 1, 3 and 4, the storage reservoir 1 comprises a connection 13 attached to the reinforcing structure 6 by being inserted simultaneously into the orifice 61 thereof and into the first orifice 47 of the liner 4, so as to be sealed to the liner 4 and to connect the inside of the liner 4, more specifically the storage compartment 5, with the outside of said storage reservoir 1, in order to enable, on one hand, the filling of the storage reservoir 1 with compound 2 and the exit of the released hydrogen. This connection 13 is intended to be connected to a valve, not shown, so as to limit the entries to or exits from said storage reservoir 1.

It is obvious that the connection 13 may also be attached to one of the flanges 7,8, without leaving the scope of the present invention.

In the embodiment example represented in FIGS. 1 to 7, each bar 3 is equipped with a connection 13. However, in order to limit the number of valves to be used, the storage reservoir 1 may only include a single bar 3 with a connection 13, without leaving the scope of the present invention. In this hypothesis, each bar 3 will then be provided with several orifices 61 on the reinforcing structure 6 thereof and with several first orifices 47 on the liner 4 thereof, at least one “orifice 61 of the reinforcing structure 6-first orifice 47 of the liner 4” assembly being disposed facing the “orifice 61 of the reinforcing structure 6-first orifice 47 of the liner 4” assembly of a similar adjacent bar 3, said two “orifice 61 of the reinforcing structure 6-first orifice 47 of the liner 4” assemblies then being connected tightly by a pipeline, not shown, connecting the respective insides of the liners of the two adjacent bars 3, each pipeline and said two associated orifice 61-first orifice 47 assemblies being preferably disposed plumb with a union member 9.

### INDUSTRIAL APPLICABILITY

It is clearly understood that the storage reservoir 1 according to the invention is preferably used to store hydrogen in solid form. However, it is obvious that the reservoir 1 can be adapted and used to contain other types of gas in solid form.

Finally, it is obvious that the examples of storage reservoirs 1 according to the invention described above are merely specific, in no way restrictive, illustrations of the invention.

1-9. (canceled)

10. A deformable reservoir for storing solid hydrogen, containing at least one compound that can absorb or release hydrogen, the reservoir comprising:
at least two rigid bars each including a polymer liner including at least a first orifice and defining at least one compartment for storing said compound and a reinforcing structure inside which said liner is accommodated, said reinforcing structure having globally the shape of a hollow cylinder closed at each of the longitudinal ends thereof respectively by a closing flange, and including at least one orifice,
a connection attached to the reinforcing structure of at least one of the bars by being inserted simultaneously into the first orifice of the liner and the orifice of the reinforcing structure, so as to be sealed to the liner and connect the inside of the storage compartment with the outside of said storage reservoir, and
a flexible union member joining two adjacent bars so to render the entire storage reservoir deformable in spite of the rigidity of each bar.

11. The reservoir according to claim 10, wherein the liner includes at least one internal partition so as to define at least two storage compartments of said compound, each internal partition including an orifice traversing same from end to end and suitable for connecting two adjacent storage compartments.

12. The reservoir according to claim 11, wherein the liner includes a second orifice provided on one of the faces thereof facing one of the flanges and plumb with each internal partition so as to lead into the two storage compartments located on either side of said internal partition and it includes a filtration clip that can be positioned, via said second orifice, on the internal partition of the liner.

13. The reservoir according to claim 12, wherein said filtration clip has a general U shape and includes two mutually parallel wings and a core connecting the two wings, each of the two wings being equipped with a through orifice disposed so as to be facing the orifice of the internal partition when the clip is positioned thereon, and the clip is equipped with a filter attached to one of the wings thereof plumb with the orifice thereof to prevent any passage of the compound.

14. The reservoir according to claim 12, wherein each second orifice of the liner is associated with a countersink provided on said liner on the opposite side to the associated internal partition and it includes a sealing member disposed in said countersink and compressed between the associated flange and the clip liner assembly.

15. The reservoir according to claim 10, wherein closing flanges are plates each equipped with a groove that can receive the longitudinal ends of the reinforcing structure.

16. The reservoir according to claim 10, wherein the liner is made of reinforced polymer material by three-dimensional printing.

17. The reservoir according to claim 10, wherein each union member is made of reinforced polymer or composite material or metal or indeed light metal alloy, the reinforced polymer union member being preferably made at the same time as the liners by three-dimensional printing.

18. The reservoir according to claim 10, wherein the closing flanges are metallic, preferably made of aluminium alloy, and the reinforcing structure is made of composite material.

19. The reservoir according to claim 13, wherein each second orifice of the liner is associated with a countersink provided on said liner on the opposite side to the associated internal partition and it includes a sealing member disposed in said countersink and compressed between the associated flange and the clip liner assembly.

20. The reservoir according to claim 11, wherein closing flanges are plates each equipped with a groove that can receive the longitudinal ends of the reinforcing structure.

21. The reservoir according to claim 12, wherein closing flanges are plates each equipped with a groove that can receive the longitudinal ends of the reinforcing structure.

22. The reservoir according to claim 13, wherein closing flanges are plates each equipped with a groove that can receive the longitudinal ends of the reinforcing structure.

23. The reservoir according to claim 14, wherein closing flanges are plates each equipped with a groove that can receive the longitudinal ends of the reinforcing structure.

24. The reservoir according to claim 11, wherein the liner is made of reinforced polymer material by three-dimensional printing.

25. The reservoir according to claim 12, wherein the liner is made of reinforced polymer material by three-dimensional printing.

26. The reservoir according to claim 13, wherein the liner is made of reinforced polymer material by three-dimensional printing.

27. The reservoir according to claim 14, wherein the liner is made of reinforced polymer material by three-dimensional printing.

28. The reservoir according to claim 15, wherein the liner is made of reinforced polymer material by three-dimensional printing.
